(19) United States
(12) Patent Application Publication
(10) Pub. No.: US 2026/0276075 A1
(43) Pub. Date: Sep. 17, 2026

(54) VEHICLE POWER TRANSMISSION DEVICE

(71) Applicant: HONDA MOTOR CO., LTD., Tokyo (JP)

(72) Inventors: Takahiro KASAHARA, Saitama (JP); Shoki YAMANAKA, Saitama (JP); Jui HSU, Saitama (JP); Dohta YAMAMOTO, Saitama (JP); Masanori KATO, Saitama (JP)

(21) Appl. No.: 19/557,382

(22) Filed: Mar. 5, 2026

(30) Foreign Application Priority Data
Mar. 14, 2025 (JP) 2025-041792

(51) Int. Cl. F16H 57/04; F16H 48/40; F16H 48/42

(52) U.S. Cl. CPC F16H 57/0483; F16H 48/40; F16H 48/42; F16H 2048/423

(57) ABSTRACT

In a vehicle power transmission device 1, an input gear 31 is arranged more outward than an end 412 in a vehicle width direction of a differential 40, a diff housing is divided into a first diff housing 44 that covers an outer side of the differential 40 and a second diff housing 33 that is arranged more outward in the vehicle width direction than the first diff housing 44, and an input shaft 32, a diff casing 41, and the first diff housing 44 are coupled to one another to rotate integrally.

This application is based on and claims the benefit of priority from Japanese Patent Application No. 2025-041792, filed on 14 Mar. 2025, the content of which is incorporated herein by reference.

### BACKGROUND OF THE INVENTION

### Field of the Invention

The present invention relates to a vehicle power transmission device.

### Related Art

Conventionally, a power transmission device in which lengths in an axial direction of the power transmission device are unequal with respect to a center of a rear differential in a vehicle has been known (for example, see Japanese Unexamined Patent Application, Publication No. 2011-43211). In the conventional power transmission device disclosed in Japanese Unexamined Patent Application, Publication No. 2011-43211, an engaging and disengaging unit and an actuator are arranged separately on both sides in an axial direction of a meshing portion where a power transmission gear meshes with an input gear, as a measure to deal with a configuration in which the lengths in the axial direction of the power transmission device are significantly unequal with respect to the center of the rear differential.

Patent Document 1: Japanese Unexamined Patent Application, Publication No. 2011-43211

### SUMMARY OF THE INVENTION

In the case where an input gear is in a position displaced outward in a vehicle width direction with respect to the body of a differential (hereinafter, referred to as “diff”) due to an arrangement position of a drive motor in an electric vehicle or the like, changing a position of the diff body to an outward side in the vehicle width direction correspondingly causes unequal lengths in the axial direction of a power transmission device. Hence, extending a diff housing outward in the vehicle width direction with the position of the diff body kept unchanged causes a problem of reduction in stiffness of the diff housing.

The present invention is made in view of the foregoing, and an object thereof is to provide a vehicle power transmission device having a configuration in which a position of an input gear is displaced outward in a vehicle width direction with respect to a diff body, so that reduction in stiffness of a diff housing is suppressed and traffic safety is improved.

In order to achieve the above-described object, the present invention provides a vehicle power transmission device including: a power transmission gear (for example, a power transmission gear 12 described later) that transmits a driving force of a drive source (for example, a motor 10 described later) for a vehicle; an input gear (for example, an input gear 31 described later) that meshes with the power transmission gear in a meshing portion and receives the driving force; an input shaft (for example, an input shaft 32 described later) provided to be rotatable integrally with the input gear; a diff casing (for example, a diff casing 41 described later) arranged on an inner circumferential side of the input shaft and being rotatable coaxially with the input shaft; a pinion (for example, a pinion 43 described later) that is borne by the diff casing so as to be rotatable on the pinion's own axis and revolves by rotation of the diff casing; a pair of side gears (for example, side gears 42 described later) that each mesh with the pinion and are relatively rotatable; a differential (for example, a diff body 40 described later) including the diff casing, the pinion, and the pair of side gears and arranged at a center in a vehicle width direction; and a diff housing (for example, a first diff housing 44 and a second diff housing 33, described later) covering the differential and the input shaft. In the vehicle power transmission device, the input gear is arranged more outward than an end in the vehicle width direction of the differential, the diff housing is divided into a first diff housing (for example, a first diff housing 44 described later) that covers an outer side of the differential and a second diff housing (for example, a second diff housing 33 described later) that is arranged more outward in the vehicle width direction than the first diff housing, and the input shaft, the diff casing, and the first diff housing are coupled to one another so as to rotate integrally.

Thus, the diff housing is divided in the vehicle width direction, so that the diff housings obtained by dividing in the vehicle width direction can each be short in the vehicle width direction even when the input gear is displaced outward in the vehicle width direction of the differential, whereby it is possible to suppress reduction in stiffness of the diff housing. That is, since the length of the first diff housing in the vehicle width direction can be short, it is possible to ensure stiffness of the first diff housing. Further, since the length of the second diff housing in the vehicle width direction can be short, it is possible to ensure stiffness of the second diff housing. Further, the distance between an axle bearing supporting the differential and the differential in the vehicle width direction can be short, whereby it is possible to achieve improvement in support stiffness of the differential.

The pair of side gears are respectively coupled to power transmission axles that transmit power to vehicle wheels, oil that lubricates the differential is included in an inside of the first diff housing, and an oil seal (for example, an oil seal 51 described later) configured to prevent leakage of the oil is provided between the first diff housing and at least one of the power transmission axles.

Thus, the diff casing and the first diff housing are coupled to each other to rotate integrally, so that the power transmission axle, the diff casing, and the first diff housing rotate at the same rotation speed when the vehicle travels in a straight line. Hence, it is possible to provide a configuration in which a rotational difference is not made between the power transmission axle and the first diff housing, it is possible to reduce friction of the differential during rotation, and it is possible to omit providing a breather.

The pair of side gears are respectively coupled to power transmission axles that transmit power to vehicle wheels, oil that lubricates the differential is included in an inside of the first diff housing, and an oil seal (for example, an oil seal 51 described later) configured to prevent leakage of the oil is provided between the diff casing or the input shaft and at least one of the power transmission axles.

Thus, the diff casing and the first diff housing are coupled to each other to rotate integrally, so that the power transmission axle, the diff casing, and the first diff housing rotate at the same rotation speed when the vehicle travels in a straight line. Hence, it is possible to provide a configuration in which a rotational difference is not made between the power transmission axle and the diff casing, it is possible to reduce friction of the differential during rotation, and it is possible to omit providing a breather.

The input shaft includes a stepped portion (for example, a radial wall 302 described later) near an end of the second diff housing that is located inward in the vehicle width direction, and a bearing (for example, an axle bearing 34 described later) that assists rotation of the input shaft is provided at the stepped portion.

Thus, it is possible to achieve improvement in stiffness of the input shaft, and, in addition, it is possible to rotate the input shaft stably through the axle bearing provided near the end of the second diff housing with improved stiffness, of the diff housing divided into the first diff housing and the second diff housing in the vehicle width direction. Further, increase in stiffness of the second diff housing and the input shaft allows the first diff housing to be more reduced in thickness than the second diff housing.

The first diff housing and the input shaft are fixed to each other by full-circumference press-fitting at a location more inward in the vehicle width direction than an end of the second diff housing.

Thus, oil is not spread to a divided part where the diff housing is divided between the first diff housing and the second diff housing, so that it is possible to omit providing an oil seal in the divided part.

The diff casing has at least one through hole that is provided from an outer circumferential surface of the diff casing with respect to an axial center of rotation of the diff casing toward an inside of the diff casing, and the at least one through hole includes a first through hole that opens by extending in a direction forming a predetermined angle in one circumferential direction around the axial center of rotation, with respect to a diameter direction passing through the axial center of rotation, when viewed in a direction along the axial center of rotation.

This allows oil to pass through the first through hole, whereby it is possible to cause a sufficient amount of oil as lubricating oil to flow on both ends which are sliding parts in the input shaft, a back surface of the pinion and side gear, and the like.

The at least one through hole includes a second through hole that opens by extending in a direction forming a predetermined angle in a direction opposite to the one circumferential direction around the axial center of rotation, with respect to the diameter direction passing through the axial center of rotation from the outer circumferential surface, when viewed in the direction along the axial center of rotation. The first through hole and the second through hole are arranged to form a V shape when viewed in the direction along the axial center of rotation.

This allows oil to pass through each of the first through hole and the second through hole, whereby it is possible to cause a sufficient amount of lubricating oil from an oil storage chamber to flow more reliably on both ends which are the sliding parts in the input shaft, the back surface of the pinion and side gear, and the like.

The at least one through hole is provided in a vicinity of the power transmission axle. Thus, when oil flows in the vicinity of the power transmission axle, it is possible to cause the oil to flow on both ends which are the sliding parts in the input shaft, the back surface of the pinion and side gear, and the like.

The at least one through hole allows oil to pass therethrough when the diff casing rotates. Thus, it is possible to cause a sufficient amount of lubricating oil from the oil storage chamber to flow on each of the vicinity of the power transmission axle, both ends which are the sliding parts in the input shaft, the back surface of the pinion and side gear, and the like when the diff casing rotates.

According to the present invention, it is possible to provide a vehicle power transmission device having a configuration in which a position of an input gear is displaced outward in a vehicle width direction with respect to a diff body, so that reduction in stiffness of a diff housing is suppressed and traffic safety is improved.

### BRIEF DESCRIPTION OF THE DRAWINGS

FIG. 1 is a partial cross-sectional view showing a vehicle power transmission device according to an embodiment of the present invention;

FIG. 2 is a cross-sectional view showing a diff body of the vehicle power transmission device according to the embodiment of the present invention;

FIG. 3 is an enlarged cross-sectional view showing a part of an end of an input shaft of the vehicle power transmission device according to the embodiment of the present invention;

FIG. 4 is a cross-sectional view taken along line A-A in FIG. 3; and

FIG. 5 is a perspective view showing the input shaft of the vehicle power transmission device according to the embodiment of the present invention.

### DETAILED DESCRIPTION OF THE INVENTION

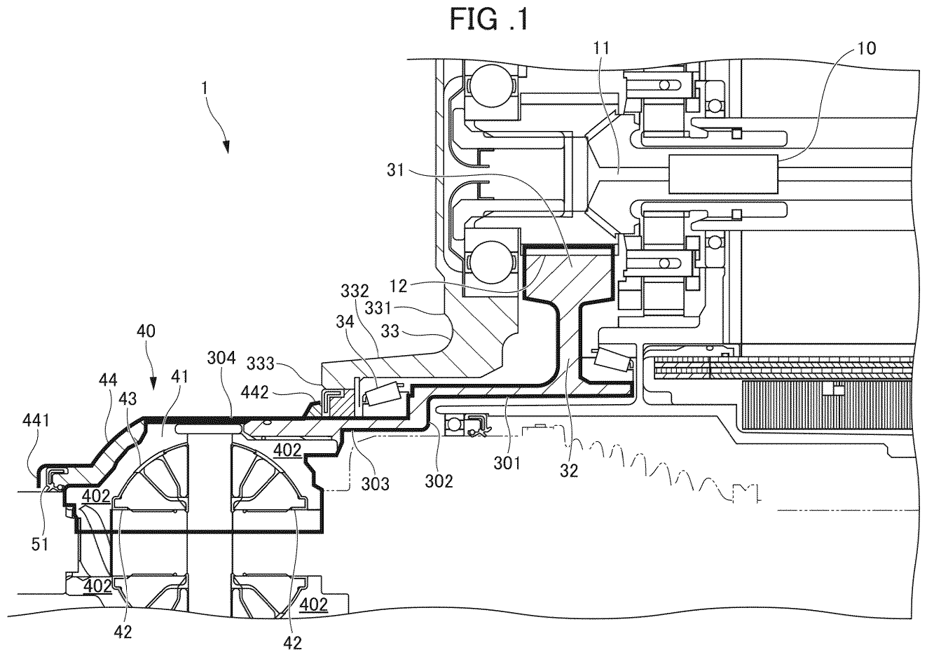

An embodiment of the present invention will be described in detail below with reference to drawings. As shown in FIG. 1, a vehicle power transmission device 1 according to the present embodiment includes a differential device in which rotational power as a driving force from a motor 10 as a drive source of a vehicle is distributed and transmitted to vehicle wheels, which are left and right driving wheels (not shown), and includes a power transmission gear 12, an input gear 31, an input shaft 32, a diff body 40, and a first diff housing 44 and a second diff housing 33 that form a diff housing.

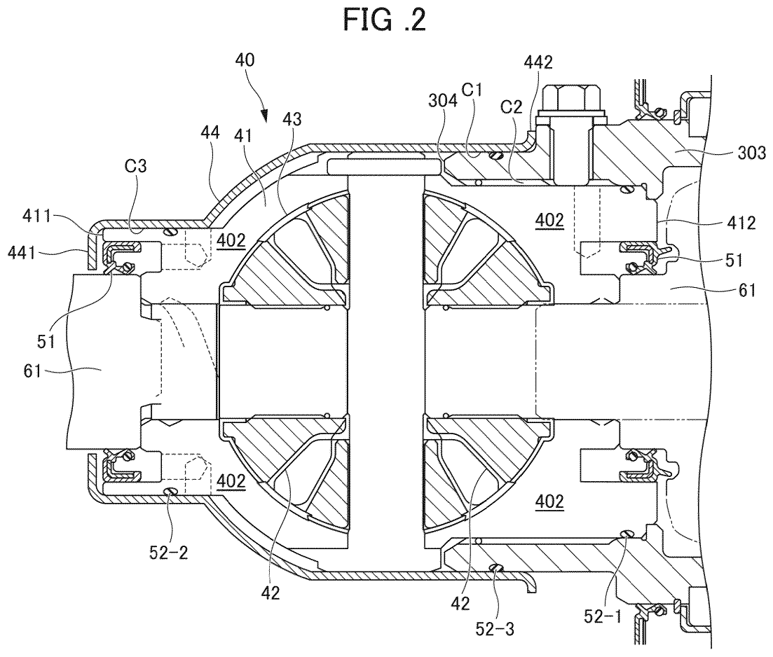

The diff body 40 forms a differential including a differential casing 41 (hereinafter referred to as “diff casing 41”), a side gear 42, and a pinion 43. The diff body 40 is arranged at a center in a vehicle width direction, which is a horizontal direction in FIG. 1. The motor 10, an output axle 11 of the motor 10, the power transmission gear 12, and the input gear 31 are arranged outward in the vehicle width direction with respect to the diff body 40, more specifically, arranged more on the right side in FIG. 2 than an end of the diff body 40 (a right end 412 of the diff casing 41 included in the diff body 40 shown in FIG. 2). FIG. 1 is a partial cross-sectional view showing the vehicle power transmission device 1. FIG. 2 is a cross-sectional view showing the diff body 40 of the vehicle power transmission device 1.

The power transmission gear 12 is positioned coaxially with the output axle 11 of the motor 10 and is provided for the output axle 11 so as to be rotatable integrally with the output axle 11 of the motor 10. The input gear 31 is positioned coaxially with the input shaft 32 having a cylindrical shape and is formed integrally with and connected to a part projecting from a circumferential surface of the input shaft 32. Thus, the input gear 31 is configured to be rotatable integrally with the input shaft 32.

An axial center of the power transmission gear 12 and an axial center of the input gear 31 are arranged parallel to each other. The input gear 31 meshes with the power transmission gear 12. This meshing part forms a meshing portion. Through the meshing portion, the input gear 31 receives a driving force from the power transmission gear 12.

The input shaft 32 having a cylindrical shape includes a larger-diameter unit 301 formed integrally with the input gear 31, and a smaller-diameter unit 303. The larger-diameter unit 301 is arranged in a position apart from the diff body 40, and a surface on an inner circumferential side (an inner circumferential surface) of the smaller-diameter unit 303 is spline-coupled to an outer circumferential surface of the diff casing 41 included in the diff body 40.

Thus, the input shaft 32 including the smaller-diameter unit 303 and the diff casing 41 are connected coaxially so as to be rotatable integrally. As shown in the bottom right of FIG. 2, an O-ring 52-1 is provided between the surface on the inner circumferential side (the inner circumferential surface) of the smaller-diameter unit 303 and the outer circumferential surface of the diff casing 41 included in the diff body 40, and sealing therebetween is performed in a state of sealing for preventing oil leakage (hereinafter referred to as “oil-tight”).

The larger-diameter unit 301 and the smaller-diameter unit 303 are formed integrally with and connected to a radial wall 302 that extends inward in a radial direction of the larger-diameter unit 301. With the radial wall 302, a part where the larger-diameter unit 301 and the smaller-diameter unit 303 are connected to each other forms a stepped portion in which a radius of the input shaft 32 decreases by one step from the larger-diameter unit 301 toward the smaller-diameter unit 303.

The diff casing 41 is configured to have a substantially spherical shape that is hollow and rotatable about an axial center, which is oriented in a horizontal direction in FIGS. 1 and 2 as the vehicle width direction and coincides with an axial center of a power transmission axle 61. The pinion 43 is supported with the diff casing 41 so as to be rotatable on its own axis, and is configured to revolve by rotation of the diff casing 41.

Further, in the diff casing 41, a pair of side gears 42 arranged to face each other are each meshed with the pinion 43 and are supported to be relatively rotatable. The pair of side gears 42 are respectively coupled to the power transmission axle 61 that transmits power to a left vehicle wheel (not shown) and the power transmission axle 61 that transmits power to a right vehicle wheel (not shown) so as to be rotatable integrally, and are supported to be rotatable relatively with respect to the diff casing 41.

The diff housing includes the first diff housing 44 and the second diff housing 33 that are divided, and covers the input shaft 32 and the diff body 40. Specifically, the first diff housing 44 has a substantially cylindrical shape and covers mainly an outer side of the diff body 40.

Further, an outer circumferential surface of an end 304 (see FIG. 2) that is inward in the vehicle width direction of the smaller-diameter unit 303 of the input shaft 32 is full-circumference press-fitted with respect to an inner circumferential surface of an end 442 of the first diff housing 44 that is more in a right part than a center position of the diff body 40 shown in FIG. 2 in the vehicle width direction. As shown in FIG. 2, an O-ring 52-3 is provided between the outer circumferential surface of the end 304 and the inner circumferential surface of the end 442 to achieve sealing therebetween in an oil-tight manner.

Thus, the input shaft 32, the diff casing 41, and the first diff housing 44 are coupled to each other so as to be rotatable integrally. A location subjected to this full-circumference press-fitting is more inward in the vehicle width direction (on the left side in FIGS. 1 and 2) than an end 333 of the second diff housing 33 in an inner side in the vehicle width direction, which is close to the diff body 40 in the vehicle width direction.

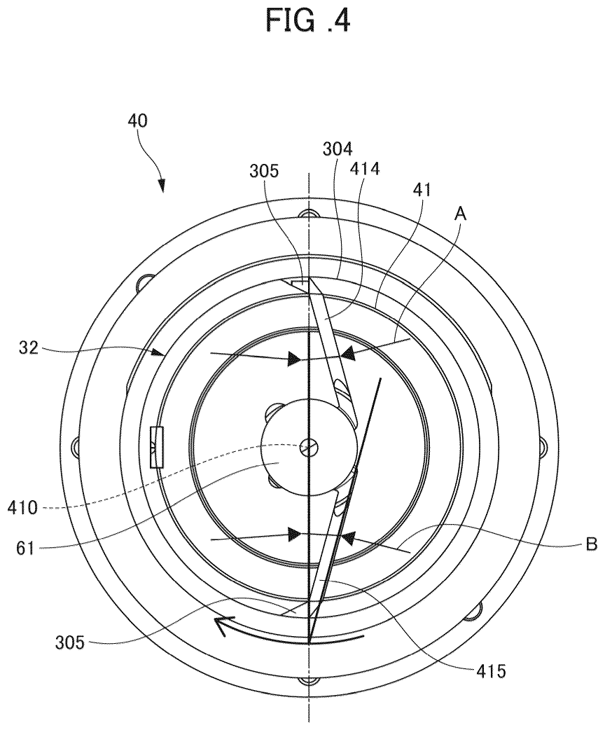

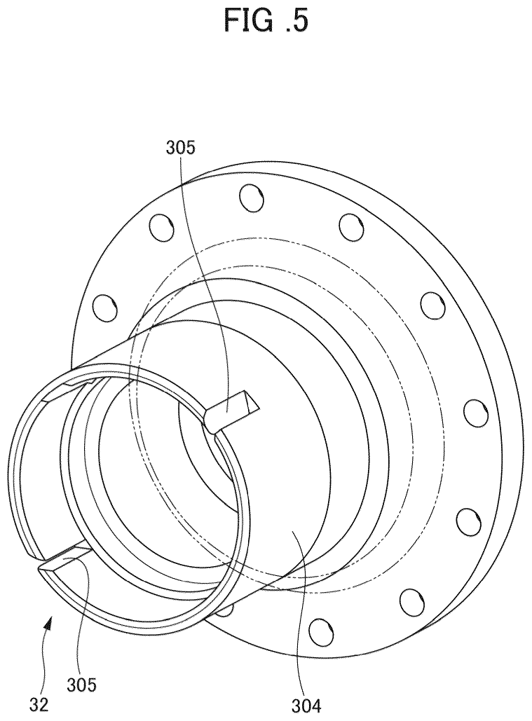

As shown in FIG. 5, notches 305 are formed in the end 304. The notches 305 include a pair of notches in a diameter position of the end 304 of the input shaft 32, and have shapes extending in a direction along an axial center of the end 304 (an upper right direction of the end 304 in FIG. 5) from an inner edge of the end 304 in the vehicle width direction (a lower left side of the end 304 in FIG. 5) and each extending obliquely to one side (the left side in FIG. 4) with respect to a diameter of the end 304 of the input shaft 32 when viewed in a direction along an axial center 410 of rotation of the diff casing 41 shown in FIG. 4. Further, the notches 305 penetrate the end 304 of the input shaft 32 to allow communication between the inner side of the end 304 and an outer side thereof.

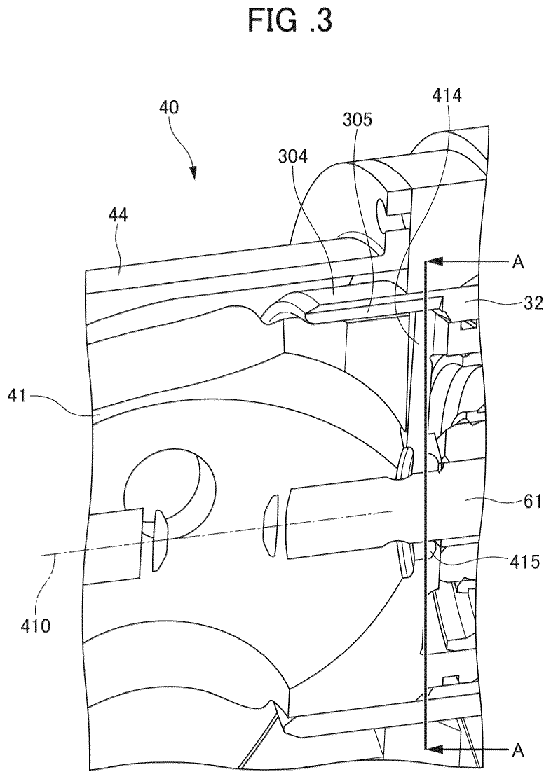

As shown in FIGS. 3 and 4, the diff casing 41 has a pair of through holes 414 and 415 provided in parts positioned in the vicinity of the power transmission axle 61, from the outer circumferential surface of the diff casing 41 with respect to the axial center of rotation of the diff casing 41 toward an inside of the diff casing 41.

The through hole 414 constitutes a first through hole that opens by extending in a direction forming a predetermined angle A in one circumferential direction around the axial center 410 of rotation (a clockwise direction around the axial center 410 of rotation in FIG. 4) with respect to a diameter direction passing through the axial center 410 of rotation so as to be apart from a circumferential surface of the power transmission axle 61, when viewed in the direction along the axial center 410 of rotation shown in FIG. 4. In other words, an angle formed by the through hole 414 and a part of a straight line indicating the diameter direction shown in FIG. 4 that is higher than the axial center 410 of rotation is the angle A.

The through hole 415 constitutes a second through hole that opens by extending in a direction forming a predetermined angle B in a direction (a counterclockwise direction around the axial center 410 of rotation in FIG. 4) opposite to the one circumferential direction (the clockwise direction around the axial center 410 of rotation in FIG. 4) around the axial center 410 of rotation with respect to the diameter direction passing through the axial center 410 of rotation, so as to be apart from the circumferential surface of the power transmission axle 61, when viewed in the direction along the axial center 410 of rotation shown in FIG. 4. In other words, an angle formed by the through hole 415 and a lower part of the straight line indicating the diameter direction shown in FIG. 4 than the axial center 410 of rotation is the angle B. The angle A and the angle B are each 15°. Dimensions represented by width and depth of each of the through holes 414 and 415 are 4 mm×8 mm. Thus, the through holes 414 and 415 are arranged to form a V shape when viewed in the direction along the axial center 410 of rotation shown in FIG. 4.

Ends of the through holes 414 and 415 that are positioned in the vicinity of a circumferential surface of the diff casing 41 are connected to and communicated with the notches 305 respectively. Thus, the through holes 414 and 415 and the notches 305 allow oil from an oil storage chamber 402 described later to pass between the inner side and the outer side of the diff casing 41 when the diff casing 41 rotates (each of clockwise rotation in FIG. 4 and counterclockwise rotation).

The oil storage chamber 402 is formed inside the first diff housing 44. In the oil storage chamber 402, oil for lubricating the diff casing 41, the side gear 42, the pinion 43, and the like that are included in the differential is stored, and the side gears 42 and the pinion 43 are soaked in the oil. An oil seal 51 is provided between the power transmission axle 61 and the first diff housing 44, more specifically, between the power transmission axle 61 and an end 411, which is more on the left side in FIG. 2 than the diff body 40 in the vehicle width direction, of the diff casing 41 positioned between the first diff housing 44 and the power transmission axle 61. With the oil seal 51, a part between the power transmission axle 61 and the end 411 is made oil-tight.

Further, the oil seal 51 is provided between the power transmission axle 61 and the diff casing 41, more specifically, between the power transmission axle 61 and the end 412 of the diff casing 41, which is more on the right side in FIG. 2 than the diff body 40 in the vehicle width direction. With the oil seal 51, a part therebetween is made oil-tight.

The second diff housing 33 is arranged more outward in the vehicle width direction than the first diff housing 44 (more on a right side than the first diff housing 44 in FIG. 1). The second diff housing 33 has a tube-like shape including a tube-like unit 332 and an extension 331 having a shape extending from an end of the tube-like unit 332, which is outward in the vehicle width direction (on the right side in FIG. 1), in a direction apart from the power transmission axle 61 (upward in FIG. 1), and the second diff housing 33 covers mainly the input shaft 32. With an axle bearing provided for the extension 331, the power transmission gear 12 is rotatably supported.

The end 333 of the tube-like unit 332 of the second diff housing 33, which is inward in the vehicle width direction (the left side in FIG. 1), is positioned near the radial wall 302 forming the stepped portion. Specifically, the end 333 is positioned more inward in the vehicle width direction (the left side in FIG. 1) than the radial wall 302 forming the stepped portion.

An axle bearing 34 is provided in an angular unit formed by the radial wall 302 forming the stepped portion and a part of the smaller-diameter unit 303 connected to the radial wall 302. The axle bearing 34 includes, for example, a bearing. The tube-like unit 332 of the second diff housing 33 is supported by the input shaft 32 through the axle bearing 34 so as to be rotatable with respect to the input shaft 32.

According to the present embodiment, the following effects are achieved. According to the present embodiment, an input gear 31 is arranged more outward than an end 412 in a vehicle width direction of a diff casing 41 in a diff body 40 as a differential, a diff housing has a configuration divided into a first diff housing 44 covering an outer side of the diff body 40 and a second diff housing 33 arranged more outward in the vehicle width direction than the first diff housing 44, and an input shaft 32, the diff casing 41, and the first diff housing 44 are coupled to one another so as to rotate integrally.

Thus, the diff housing is divided in the vehicle width direction, so that the diff housings divided in the vehicle width direction can each be short in the vehicle width direction even when the input gear 31 is displaced outward in the vehicle width direction of the diff body 40, whereby it is possible to suppress reduction in stiffness of the diff housing.

That is, since a length of the first diff housing 44 in the vehicle width direction can be short, it is possible to ensure stiffness of the first diff housing 44. Since a length of the second diff housing 33 in the vehicle width direction can be short, it is possible to ensure stiffness of the second diff housing 33. Further, a distance between an axle bearing 34 including a bearing or the like and the diff body 40 in the vehicle width direction can be short, whereby it is possible to achieve improvement in support stiffness of the diff body 40.

According to the present embodiment, a pair of side gears 42 are respectively coupled to power transmission axles 61 that transmit power to driving wheels (not shown), oil that lubricates the diff body 40 as the differential is included in an inside of the first diff housing 44, and an oil seal 51 that prevents leakage of the oil is provided between the first diff housing 44 and the power transmission axle 61.

Thus, the diff casing 41 and the first diff housing 44 are coupled to each other to rotate integrally, so that the power transmission axle 61, the diff casing 41, and the first diff housing 44 rotate at the same rotation speed when a vehicle travels in a straight line. Thus, it is possible to provide a configuration in which a rotational difference is not made between the power transmission axle 61 and the first diff housing 44, it is possible to reduce friction of the diff body 40 during rotation as the differential, and it is possible to omit providing a breather.

According to the present embodiment, a pair of side gears 42 are respectively coupled to power transmission axles 61 that transmit power to driving wheels (not shown), oil that lubricates the diff body 40 as the differential is included in an inside of the first diff housing 44, and an oil seal 51 that prevents leakage of the oil is provided between the diff casing 41 and the power transmission axle 61.

Thus, the diff casing 41 and the first diff housing 44 are coupled to each other to rotate integrally, so that the power transmission axle 61, the diff casing 41, and the first diff housing 44 rotate at the same rotation speed when a vehicle travels in a straight line. Hence, it is possible to provide a configuration in which a rotational difference is not made between the power transmission axle 61 and the diff casing 41, it is possible to reduce friction of the diff body 40 during rotation as the differential, and it is possible to omit providing a breather.

According to the present embodiment, the input shaft 32 includes a radial wall 302 forming a stepped portion near an end 333 of the second diff housing 33 that is located inward in the vehicle width direction, and an axle bearing 34 including a bearing that assists rotation of the input shaft 32 is provided at the radial wall 302 forming the stepped portion.

Thus, it is possible to achieve improvement in stiffness of the input shaft 32, and, in addition, it is possible to rotate the input shaft 32 stably through the axle bearing 34 provided near the end 333 of the second diff housing 33 with improved stiffness, of the diff housing divided into the first diff housing 44 and the second diff housing 33 in the vehicle width direction. Further, increase in stiffness of the second diff housing 33 and the input shaft 32 allows the first diff housing 44 to be more reduced in thickness than the second diff housing 33.

According to the present embodiment, the first diff housing 44 and the input shaft 32 are fixed to each other by full-circumference press-fitting at a location more inward in the vehicle width direction than an end 333 of the second diff housing 33.

Thus, oil is not spread to a divided part where the diff housing is divided between the first diff housing 44 and the second diff housing 33, and it is possible to omit providing an oil seal in the divided part.

According to the present embodiment, the diff casing 41 includes through holes 414 and 415 that are provided from an outer circumferential surface of the diff casing 41 with respect to an axial center 410 of rotation of the diff casing 41 toward an inside of the diff casing 41, and the through holes 414 and 415 include a first through hole 414 that opens by extending in a direction forming a predetermined angle A in one circumferential direction around the axial center 410 of rotation, with respect to a diameter direction passing through the axial center 410 of rotation, when viewed in a direction along the axial center 410 of rotation.

This allows oil to pass through the first through hole 414, so that it is possible to cause a sufficient amount of lubricating oil from an oil storage chamber 402 to flow on both ends which are sliding parts in the input shaft 32, a back surface of the pinion 43 and side gear 42, and the like.

According to the present embodiment, the through holes 414 and 415 include a second through hole that opens by extending in a direction forming a predetermined angle B in a direction opposite to the one circumferential direction around the axial center 410 of rotation, with respect to the diameter direction passing through the axial center 410 of rotation from the outer circumferential surface, when viewed in the direction along the axial center 410 of rotation, and the first through hole 414 and the second through hole 415 are arranged to form a V shape when viewed in the direction along the axial center 410 of rotation.

This allows oil to pass through each of the first through hole 414 and the second through hole 415, whereby it is possible to cause a sufficient amount of lubricating oil from an oil storage chamber 402 to flow more reliably on both ends which are sliding parts in the input shaft 32, a back surface of the pinion 43 and side gear 42, and the like.

According to the present embodiment, the first through hole 414 and the second through hole 415 are provided in a vicinity of the power transmission axle 61. Thus, when oil flows in the vicinity of the power transmission axle 61, it is possible to cause the oil to flow on both ends which are sliding parts in the input shaft 32, a back surface of the pinion 43 and side gear 42, and the like.

According to the present embodiment, the first through hole 414 and the second through hole 415 cause oil to pass therethrough when the diff casing 41 rotates. Thus, it is possible to cause a sufficient amount of lubricating oil from the oil storage chamber 402 to flow on each of the vicinity of the power transmission axle 61, both ends which are sliding parts in the input shaft 32, a back surface of the pinion 43 and side gear 42, and the like when the diff casing 41 rotates.

The present invention is not limited to the above-described embodiment, and the present invention includes modification, improvement, and the like within the scope that can achieve the object of the present invention.

For example, the motor 10 is used as the drive source in the above-described embodiment; however, the above-described embodiment is not limited to this.

Further, the oil seal 51 that prevents oil leakage is provided between the first diff housing 44 and the power transmission axle 61, and the oil seal 51 that prevents oil leakage is provided between the diff casing 41 and the power transmission axle 61 in the above-described embodiment; however, the above-described embodiment is not limited to this configuration. It is only required that the oil seal that prevents oil leakage is provided between the first diff housing and at least one power transmission axle and the oil seal that prevents oil leakage is provided between the diff casing or the input shaft and at least one power transmission axle.

Further, the angle A and the angle B are each 15° and dimensions represented by width and depth of each of the through holes 414 and 415 are 4 mm×8 mm in the above-described embodiment; however, the above-described embodiment is not limited to this. Values other than these are acceptable as long as it is possible to scoop oil in the through holes 414 and 415 effectively.

The configuration of the power transmission gear, the input gear, the input shaft, the diff body, and the like is not limited to the configuration of the power transmission gear 12, the input gear 31, the input shaft 32, the diff body 40, and the like in the above-described embodiment.

### EXPLANATION OF REFERENCE NUMERALS

1 vehicle power transmission device
10 motor (drive source)
31 input gear
32 input shaft
33 second diff housing (diff housing)
34 axle bearing (bearing)
40 diff body (differential)
41 diff casing
42 side gear
43 pinion
44 first diff housing (diff housing)
51 oil seal
61 power transmission axle
302 radial wall (stepped portion)
333 end
412 end

What is claimed is:

1. A vehicle power transmission device comprising:
a power transmission gear that transmits a driving force of a drive source for a vehicle;
an input gear that meshes with the power transmission gear in a meshing portion and receives the driving force;
an input shaft provided to be rotatable integrally with the input gear;
a diff casing arranged on an inner circumferential side of the input shaft and being rotatable coaxially with the input shaft;
a pinion that is borne by the diff casing so as to be rotatable on the pinion's own axis and revolves by rotation of the diff casing;
a pair of side gears that each mesh with the pinion and are relatively rotatable;
a differential including the diff casing, the pinion, and the pair of side gears and arranged at a center in a vehicle width direction; and
a diff housing covering the differential and the input shaft, wherein
the input gear is arranged more outward than an end in the vehicle width direction of the differential,
the diff housing is divided into a first diff housing that covers an outer side of the differential and a second diff housing that is arranged more outward in the vehicle width direction than the first diff housing, and
the input shaft, the diff casing, and the first diff housing are coupled to one another so as to rotate integrally.

2. The vehicle power transmission device according to claim 1, wherein
the pair of side gears are respectively coupled to power transmission axles that transmit power to vehicle wheels,
oil that lubricates the differential is included in an inside of the first diff housing, and
an oil seal configured to prevent leakage of the oil is provided between the first diff housing and at least one of the power transmission axles.

3. The vehicle power transmission device according to claim 1, wherein
the pair of side gears are respectively coupled to power transmission axles that transmit power to vehicle wheels,
oil that lubricates the differential is included in an inside of the first diff housing, and
an oil seal configured to prevent leakage of the oil is provided between the diff casing or the input shaft and at least one of the power transmission axles.

4. The vehicle power transmission device according to claim 1, wherein
the input shaft includes a stepped portion near an end of the second diff housing, the end being located inward in the vehicle width direction, and
a bearing that assists rotation of the input shaft is provided at the stepped portion.

5. The vehicle power transmission device according to claim 1, wherein the first diff housing and the input shaft are fixed to each other by full-circumference press-fitting at a location more inward in the vehicle width direction than an end of the second diff housing.

6. The vehicle power transmission device according to claim 2, wherein
the diff casing has at least one through hole that is provided from an outer circumferential surface of the diff casing with respect to an axial center of rotation of the diff casing toward an inside of the diff casing, and
the at least one through hole includes a first through hole that opens by extending in a direction forming a predetermined angle in one circumferential direction around the axial center of rotation, with respect to a diameter direction passing through the axial center of rotation, when viewed in a direction along the axial center of rotation.

7. The vehicle power transmission device according to claim 6, wherein
the at least one through hole includes a second through hole that opens by extending in a direction forming a predetermined angle in a direction opposite to the one circumferential direction around the axial center of rotation, with respect to the diameter direction passing through the axial center of rotation from the outer circumferential surface, when viewed in the direction along the axial center of rotation, and
the first through hole and the second through hole are arranged to form a V shape when viewed in the direction along the axial center of rotation.

8. The vehicle power transmission device according to claim 6, wherein the at least one through hole is provided in a vicinity of the power transmission axle.

9. The vehicle power transmission device according to claim 6, wherein the at least one through hole allows the oil to pass therethrough when the diff casing rotates.
